(19) United States
(12) Patent Application Publication
(10) Pub. No.: US 2026/0210165 A1
(43) Pub. Date: Jul. 23, 2026

(54) HINGE

(71) Applicant: SUGATSUNE KOGYO CO., LTD., Tokyo (JP)

(72) Inventors: Yukihiko OGAWA, Tokyo (JP); Manabu HASEGAWA, Tokyo (JP); Naoya IWATA, Tokyo (JP)

(21) Appl. No.: 19/568,788

(22) Filed: Mar. 17, 2026

Related U.S. Application Data
(63) Continuation of application No. PCT/JP2024/036372, filed on Oct. 11, 2024.

(30) Foreign Application Priority Data
Oct. 27, 2023 (JP) 2023-184432

(51) Int. Cl. E05D 11/00; E05D 3/16

(52) U.S. Cl. CPC E05D 11/00; E05D 3/16; E05D 2003/166; E05Y 2600/56; E05Y 2600/63; E05Y 2900/132

(57) ABSTRACT

A hinge is provided that can facilitate a work of temporarily securing a hinge body to a base frame. A locking member (41) is slidably provided on one of a base frame (4) or a hinge body (3), and a biasing member (42) that biases the locking member (41) is provided. The hinge body (3) is configured to be temporarily secured to the base frame (4) using the locking member (41).

### CROSS-REFERENCE TO RELATED APPLICATIONS

This Application claims the benefit of priority and is a Continuation application of the prior International Patent Application No. PCT/JP 2024/036372, with an international filing date of Oct. 11, 2024, which designated the United States, and is related to the Japanese Patent Application No. 2023-184432, filed Oct. 27, 2023, the entire disclosures of all applications are expressly incorporated by reference in their entirety herein.

### TECHNICAL FIELD

The present invention relates to a hinge in which a hinge body attached to a door and a hinge body attached to a mounting member (e.g., a frame, a cabinet body, a wall) of the door are connected so as to be openable and closable.

### BACKGROUND OF THE INVENTION

As shown in FIG. 12, a hinge in which a hinge body 51 attached to a door and a hinge body 52 attached to a mounting member of a door are connected so as to be openable and closable is known. A base frame 53 is used to facilitate mounting of the door to the mounting member. Namely, the hinge body 51 is fixed to the door, the base frame 53 is fixed to the mounting member, and the hinge body 52 is fitted and fixed to the base frame 53 while the door is supported.

However, when the hinge body 52 is disengaged from the base frame 53 in a state where the hinge body 52 is fitted into the base frame 53, the hinge body 52 cannot be fixed to the base frame 53 using screws 54. To prevent this, the hinge body 52 is temporarily secured to the base frame 53. Namely, a hole 53a is provided in a lower portion of the base frame 53, a protrusion 52a is provided in a lower portion of the hinge body 52, and the protrusion 52a of the hinge body 52 is fitted into the hole 53a of the base frame 53 in a state where the hinge body 52 is fitted into the base frame 53. Thus, the hinge body 52 is temporarily secured to the base frame 53 by the weight of the door. A similar temporary securing structure for a hinge is also disclosed in FIG. 4 of Patent Document 1.

### PRIOR ART DOCUMENT

### Patent Documents

Patent Document 1: Japanese U.S. Pat. No. 5,065,848

### SUMMARY OF THE INVENTION

### Problem to be Solved by the Invention

However, in the conventional hinge, since the hole 53a of the base frame 53 and the protrusion 52a of the hinge body 52 are located on the back side, they are difficult to see, and it is difficult to confirm whether the protrusion 52a is fitted into the hole 53a.

The present invention provides a hinge that can facilitate a work of temporarily securing a hinge body to a base frame.

### Means for Solving the Problems

One aspect of the present invention is a hinge in which a first hinge body attached to a door and a second hinge body attached to a mounting member of the door are connected so as to be openable and closable, one of the first hinge body attached to the door or the second hinge body attached to the mounting member of the door is fitted and fixed to a base frame fixed to one of the door or the mounting member of the door, a locking member is slidably provided on one of the base frame, the first hinge body or the second hinge body, a biasing member that biases the locking member is provided, and the hinge body is configured to be temporarily secured to the base frame using the locking member.

### Effects of the Invention

According to the present invention, a work of temporarily securing the hinge body to the base frame can be facilitated.

### BRIEF DESCRIPTION OF DRAWINGS

FIG. 1 is a perspective view of a hinge according to the first embodiment of the present invention.

FIG. 2 is a perspective view of the hinge according to the present embodiment for fitting and fixing a hinge body to a base frame.

FIG. 3 is an exploded perspective view of the hinge according to the present embodiment.

FIG. 4 is an exploded perspective view of a main part of the hinge according to the present embodiment.

FIG. 5 is a perspective view of a locking member.

FIGS. 6A and 6B are horizontal sectional views of a main part of the hinge according to the present embodiment. FIG. 6A shows a protruded position of the locking member. FIG. 6B shows a retracted position of the locking member.

FIG. 7A1-7A3 and 7B1-7B3 are an example of operation diagrams for fitting the hinge body to the base frame. FIG. 7B1 to 7B3 are sectional views taken along line b-b of FIG. 7A1 to 7A3.

FIG. 8A1-8A4, 8B1-8B4 and 8C1-8C4 are an example of operation diagrams for removing the hinge body from the base frame. FIG. 8B1 to 8B4 are sectional views taken along line b-b of FIG. 8A1 to 8A4. FIG. 8C1 to 8C4 are views as seen from the direction of arrow c in FIG. 8A1 to 8A4.

FIG. 9A1-9A3, 9B1-9B3 and 9C1-9C3 are another example of operation diagrams fitting the hinge body to the base frame. FIG. 9B1 to 9B3 are sectional views taken along line b-b of FIG. 9A1 to 9A3. FIG. 9C1 to 9C3 are views as seen from the direction of arrow c in FIG. 9A1 to 9A3.

FIG. 10 is a perspective view of a main part of a hinge according to the second embodiment of the present invention.

FIG. 11A is a perspective view showing a state where the hinge body is temporarily secured to the base frame. FIG. 11B is a perspective view showing a state where the locking member is held in the retracted position.

FIG. 12 is a perspective view showing a conventional hinge.

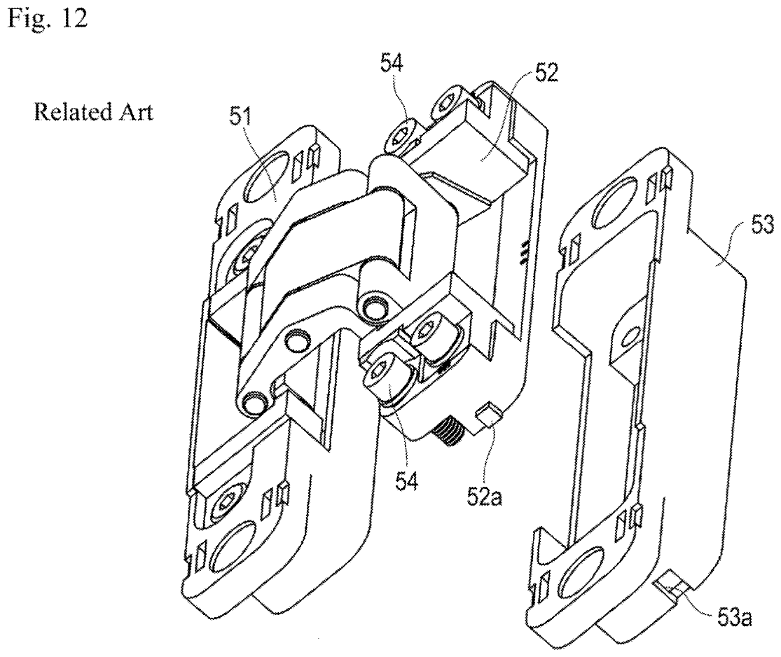

### DETAILED DESCRIPTION OF THE INVENTION

Hereinafter, a hinge according to an embodiment of the present invention will be explained in detail with reference to the attached drawings. However, the hinge of the present invention can be embodied in various forms and is not limited to the embodiment described in the present specification. The present embodiment is provided with an intent to enable those skilled in the art to fully understand the invention by sufficiently disclosing the specification.

### First Embodiment

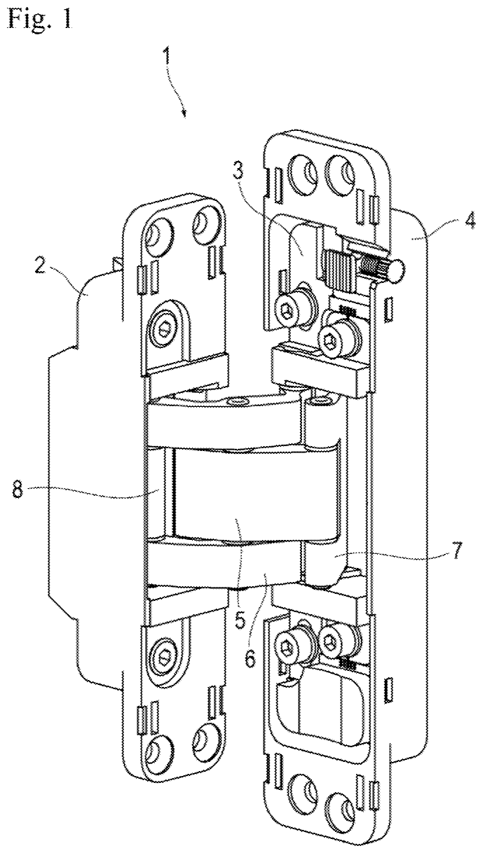

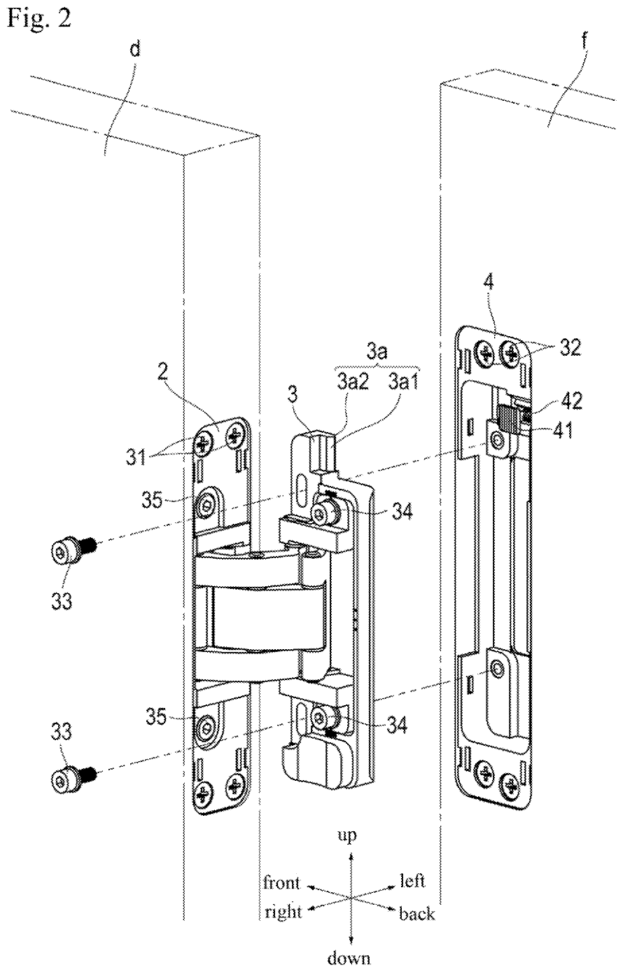

As shown in FIG. 1 and FIG. 2, a hinge 1 according to the first embodiment of the present invention is a concealed hinge including a hinge body 2 attached to a door d and a hinge body 3 attached to a mounting member f (e.g., a frame, a cabinet, a wall) of the door. The hinge body 2 and the hinge body 3 are connected via a plurality of arms 5 to 8 so as to be openable and closable.

Typically, a plurality of hinges is provided at upper and lower portions of the door d. Although not particularly limited, the hinge 1 of the present embodiment may be provided in some of the plurality of hinges as long as the door d does not fall off.

Hereinafter, the configuration of the hinge 1 will be explained using directions when viewing the door d in the closed position from the opening side (i.e., using directions of up and down, left and right and front and back as shown in FIG. 2).

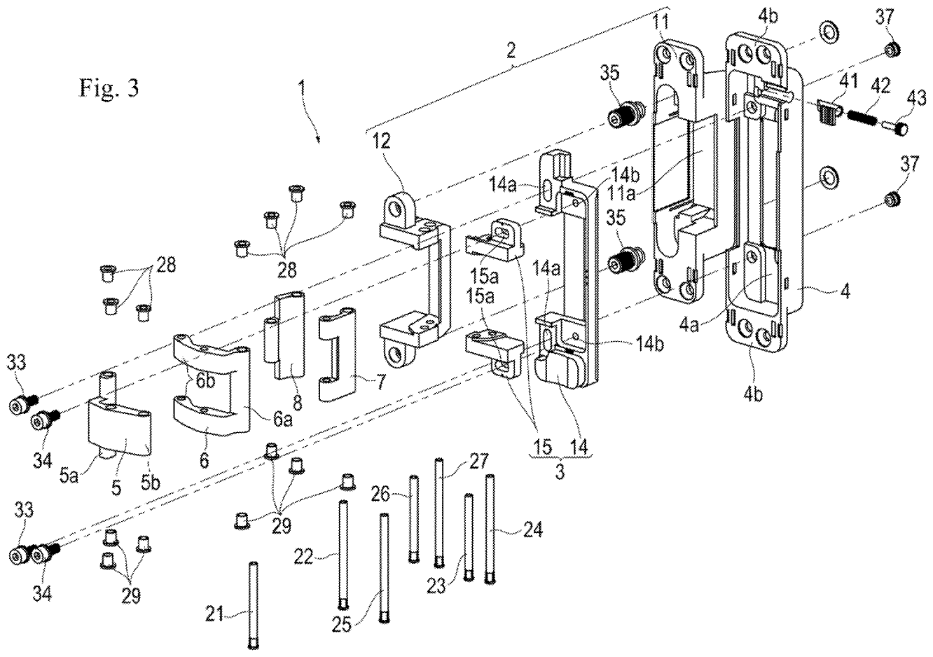

As shown in FIG. 1, the plurality of arms 5 to 8 includes center arms 5, 6 and side arms 7, 8. As shown in FIG. 3, the center arms 5, 6 are formed in a substantially V-shape in a plan view and are rotatably connected by a shaft 21 such that the center arms 5, 6 cross at a substantially central portion.

A base portion 5a of the center arm 5 is rotatably connected to a shaft 22 supported by a bracket 12 of the hinge body 2. A tip portion 5b of the center arm 5 is rotatably connected to a tip portion of the side arm 7 by a shaft 23. A base end portion of the side arm 7 is rotatably connected to a shaft 24 supported by brackets 15 of the hinge body 3.

A base portion 6a of the center arm 6 is rotatably connected to a shaft 25 supported by the brackets 15 of the hinge body 3. A tip portion 6b of the center arm 6 is rotatably connected to a tip portion of the side arm 8 by a shaft 26. A base end portion of the side arm 8 is rotatably connected to a shaft 27 supported by the bracket 12 of the hinge body 2. The reference numerals 28 and 29 show spacers for preventing metal-to-metal contact.

The configuration of the arms 5 to 8 is not limited to the above. For example, the side arms 7, 8 may be omitted, and the tip portions of the center arms 5, 6 may be rotatably and slidably connected to the bracket 12 of the hinge body 2 and the brackets 15 of the hinge body 3 by shafts. Alternatively, the hinge 1 may be a single-axis hinge, and the hinge body 2 and the hinge body 3 may be rotatably connected to each other via a shaft.

As shown in FIG. 2, the hinge body 2 is fitted into a recess provided in an edge surface of the door d and then fixed to the door d by screws 31. Note that a base frame (not illustrated) may be fixed to the door d and the hinge body 2 may be fitted and fixed to the base frame.

On the other hand, the hinge body 3 is fitted and fixed to a base frame 4 fixed to the mounting member f of the door. Namely, the base frame 4 is fitted into a recess provided in an inner surface of the mounting member f, the base frame 4 is fixed to the mounting member f of the door by screws 32, then the hinge body 3 is fitted into the base frame 4 and fixed to the base frame 4 by screws 33.

As shown in FIG. 3, the base frame 4 has a recess 4a elongated in the vertical direction. The recess 4a is formed by a bottom wall and side walls that surround the bottom wall in a frame shape. A length of the recess 4a in the vertical direction is longer than a length of the hinge body 3 in the vertical direction by a predetermined length. The hinge body 3 can be fitted into and removed from the recess 4a and can be moved in the vertical direction. Flanges 4b are extended from upper and lower side walls of the base frame 4. Through holes for the screws 32 (shown in FIG. 2) are formed in the flanges 4b.

The hinge body 3 is provided with up-down position adjustment screws 33 and front-back position adjustment screws 34 for the door d. The hinge body 2 is provided with left-right position adjustment screws 35 for the door d. An example of a position adjustment structure will be explained below. However, the position adjustment structure is not limited thereto.

The base frame 4 is provided with insert nuts (female screws) 37 into which the up-down position adjustment screws 33 are screwed. The insert nuts 37 may be integrally formed with the base frame 4. The hinge body 3 includes a body frame 14 fixed to the base frame 4 such that the up-down position is adjustable, and brackets 15 fixed to the body frame 14 such that the front-back position is adjustable.

The body frame 14 is formed with elongated holes 14a extending in the up-down direction through which the up-down position adjustment screws 33 pass. In a state that the up-down position adjustment screws 33 are loosened, the body frame 14 can be moved and adjusted in the up-down direction relative to the base frame 4. After the adjustment, the body frame 14 is fixed to the base frame 4 using the up-down position adjustment screws 33.

The body frame 14 is formed with screw holes 14b into which the front-back position adjustment screws 34 are screwed. Each of the brackets 15 is formed with an elongated hole 15a extending in the front-back direction through which the front-back position adjustment screws 34 pass. In a state that the front-back position adjustment screws 34 are loosened, the brackets 15 can be moved and adjusted in the front-back direction relative to the body frame 14.

The hinge body 2 includes a body frame 11 fixed to the door d and a bracket 12 fixed to the body frame 11 such that the left-right position is adjustable. The body frame 11 is formed with a recess 11a having a shape conforming to the bracket 12. The body frame 11 supports the left-right adjustment screws 35 such that the left-right adjustment screws 35 are rotatable and immovable in the axial direction. The left-right adjustment screws 35 are screwed into the bracket 12. When the left-right adjustment screws 35 are rotated, the bracket 12 moves in the left-right direction relative to the body frame 11 by the action of a feed screw.

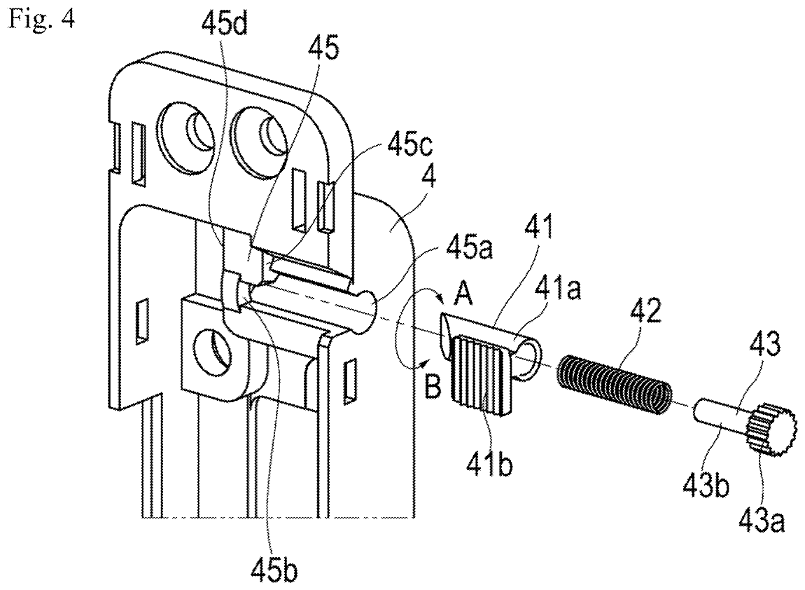

As shown in FIG. 4, a locking member 41 is slidably provided on the base frame 4. A biasing member 42 that biases the locking member 41 is also provided on the base frame 4. The hinge body 2 is temporarily secured to the base frame 4 using the locking member 41.

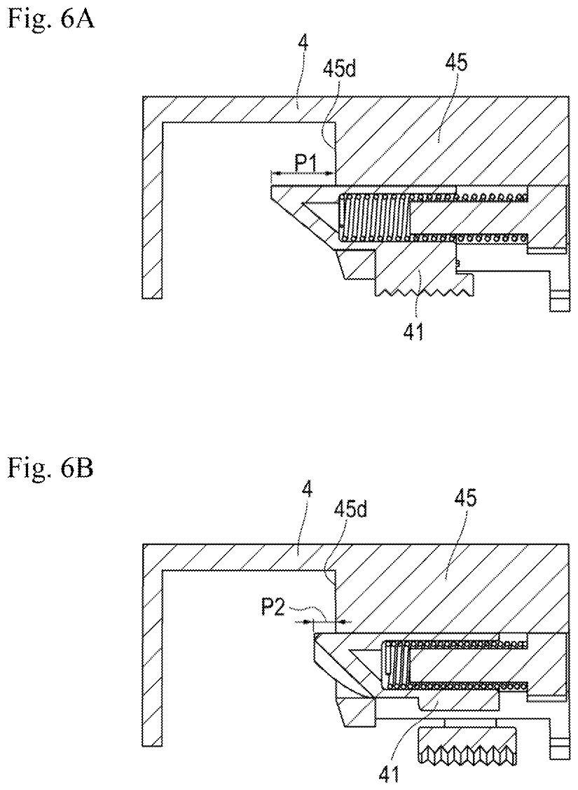

The position of the locking member 41 can be held at a protruded position shown in FIG. 6A and a retracted position shown in FIG. 6B that is more retracted than the protruded position. A protrusion amount of the locking member 41 from a wall surface 45d at the protruded position is indicated by P1, and a protrusion amount of the locking member 41 from the wall surface 45d at the retracted position is indicated by P2.

As shown in FIG. 4, the locking member 41 is rotated in a locking direction A and an unlocking direction B to switch the position of the locking member 41 between the retracted position and the protruded position.

A wall portion 45 having a wall surface 45d facing a cam 3a (shown in FIG. 2) of the hinge body 3 is formed in an upper portion of the base frame 4. The wall portion 45 is formed with a guide groove 45a having an arcuate cross-section that slidably guides a slide shaft 41a of the locking member 41. The locking member 41 can rotate by a predetermined angle in the locking direction A and the unlocking direction B about the slide shaft 41a. The wall portion 45 is formed with a first stopper 45b and a second stopper 45c against which the locking member 41 abuts.

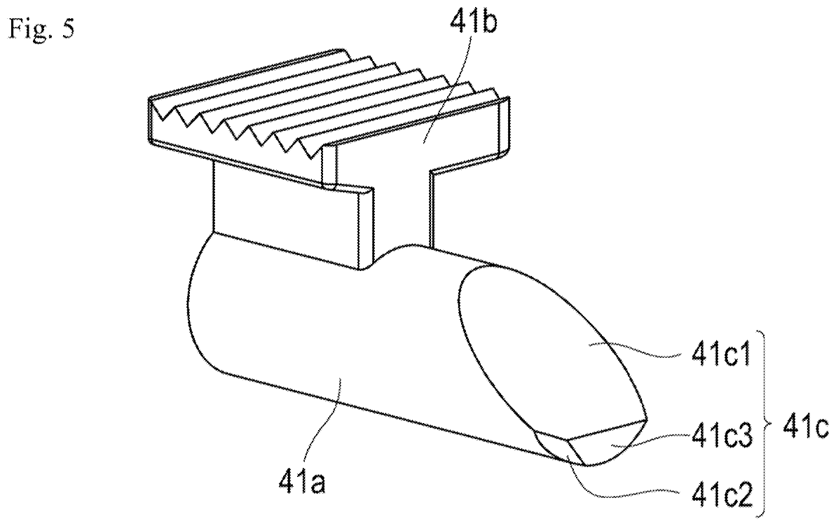

As shown in FIG. 5, the locking member 41 includes a slide shaft 41a and an actuation plate 41b integrally formed on an outer surface of the slide shaft 41a. The slide shaft 41a has a bottomed cylindrical shape (shown in FIG. 4). The biasing member 42 is accommodated inside the slide shaft 41a.

A cam 41c is formed at a tip portion of the slide shaft 41a. The cam 41c includes a first cam surface 41c1 consisting of a large inclined surface on the front side, a second cam surface 41c2 consisting of a small inclined surface on the back side and an abutment cam surface 41c3 perpendicular to the slide shaft 41a.

The actuation plate 41b has a substantially T-shape when viewed in the axial direction. Serrations are formed on an upper surface of the actuation plate 41b for slip prevention.

As shown in FIG. 4, the biasing member 42 is, for example, a coil spring. The biasing member 42 is interposed between the locking member 41 and a spring receiver 43 to bias the locking member 41 toward the hinge body 3. The biasing member 42 is not limited to the coil spring and may be a disc spring, a plate spring or the like.

The spring receiver 43 is fixed to an end portion of the guide groove 45a of the base frame 4. The spring receiver 43 includes a large-diameter knurled portion 43a fixed to the end portion of the guide groove 45a and a small-diameter support shaft 43b inserted into the biasing member 42.

As shown in FIG. 4, when an operator presses a lower end portion of the actuation plate 41b of the locking member 41 to rotate the locking member 41 in the unlocking direction B, the locking member 41 is biased by the biasing member 42 to slide in a forward direction and the actuation plate 41b abuts against the first stopper 45b. Thus, the position of the locking member 41 can be held at the protruded position (FIG. 6A). On the other hand, when the operator slides the actuation plate 41b of the locking member 41 in a backward direction against the biasing member 42 and presses an upper end portion of the actuation plate 41b to rotate the locking member 41 in the locking direction A, the actuation plate 41b abuts against the second stopper 45c. Thus, the position of the locking member 41 can be held at the retracted position (FIG. 6B).

As shown in FIG. 2, when the hinge body 3 is fitted into the base frame 4, the hinge body 3 contacts the locking member 41 and the locking member 41 slides. A cam 3a extending in the vertical direction is formed at an upper end portion of the hinge body 3. The cam 3a has a V-shaped cross-section and includes a first cam surface 3a1 on the front side and a second cam surface 3a2 on the back side. The first cam surface 3a1 and the second cam surface 3a2 are formed as flat inclined surfaces.

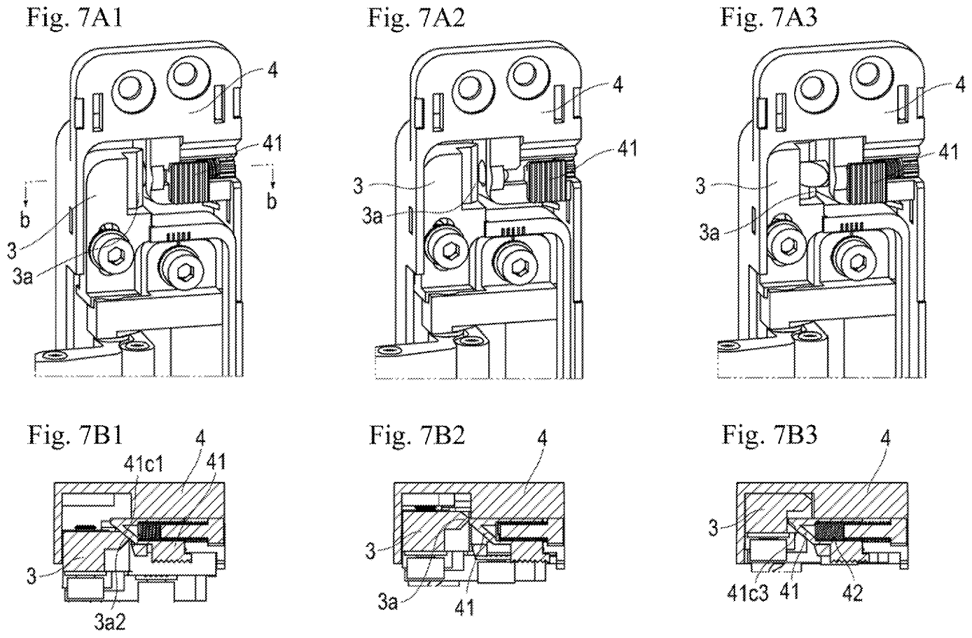

FIG. 7A1-7A3 and 7B1-7B3 show an example of operation diagrams for fitting the hinge body 3 to the base frame 4. In this example, the position of the locking member 41 is held at the protruded position (FIG. 6A). As shown in FIG. 7A1 and 7B1, when the hinge body 3 is fitted into the base frame 4, the second cam surface 3a2 of the cam 3a of the hinge body 3 contacts the first cam surface 41c1 of the cam 41c of the locking member 41 and the locking member 41 slides in the backward direction. After that, as shown in FIG. 7A2 and 7B2, when the cam 3a of the hinge body 3 passes over the cam 41c of the locking member 41, the biasing member 42 biases the locking member 41 to slide in the forward direction toward the hinge body 3 as shown in FIG. 7A3 and 7B3. At this time, the locking member 41 advances to the protruded position or until the abutment cam surface 41c3 abuts against the hinge body 3. Therefore, the hinge body 3 can be prevented from coming off from the base frame 4, and the hinge body 3 can be temporarily secured to the base frame 4.

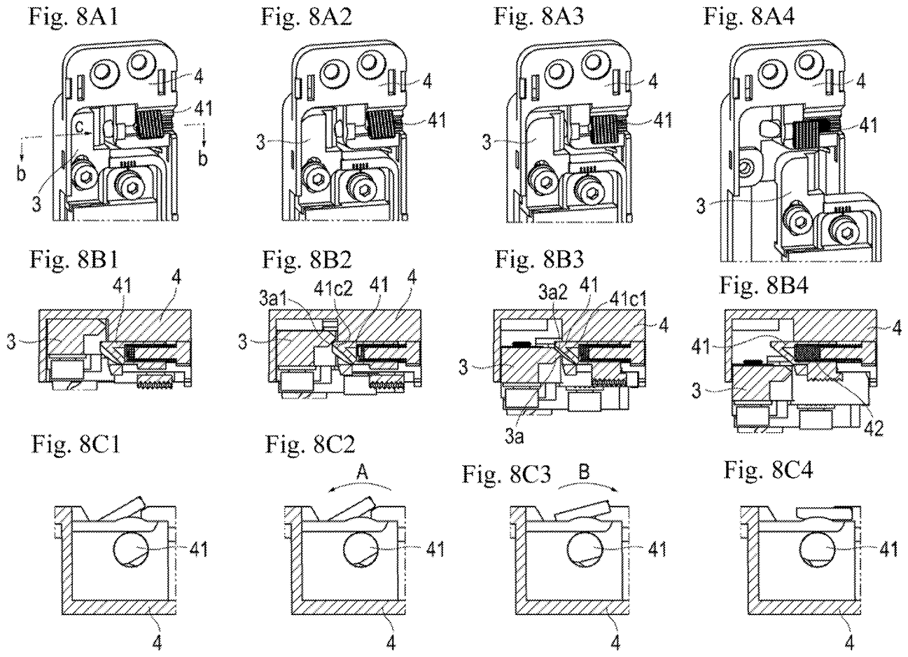

FIG. 8A1-8A4, 8B1-8B4 and 8C1-8C4 show an example of operation diagrams for removing the hinge body 3 from the base frame 4. In this example, as shown in FIG. 8A1, the operator slides the locking member 41 in the backward direction and then rotates the locking member 41 in the locking direction to hold the position of the locking member 41 at the retracted position (FIG. 8B1). Then, as shown in FIG. 8A2 and 8B2, when the hinge body 3 is pulled out from the base frame 4, the first cam surface 3a1 of the cam 3a of the hinge body 3 contacts the second cam surface 41c2 of the cam 41c of the locking member 41, and the locking member 41 slides in the backward direction. At this time, as shown in FIG. 8C2, torque is applied to the locking member 41 in the locking direction A by the first cam surface 3a1 of the hinge body 3 and the second cam surface 41c2 of the locking member 41. Therefore, the locking member 41 slides while maintaining the locked state. After that, as shown in FIG. 8A3 and 8B3, when the cam 3a of the hinge body 3 passes over the cam 41c of the locking member 41, the biasing member 42 slides the locking member 41 in the forward direction toward the hinge body 3 as shown in FIG. 8A4 and 8B4. At this time, as shown in FIG. 8C3, torque in the unlocking direction B is applied to the locking member 41 by the second cam surface 3a2 of the hinge body 3 and the first cam surface 41c1 of the locking member 41, and the locking member 41 advances to the protruded position (FIG. 8B4) while rotating in the unlocking direction B.

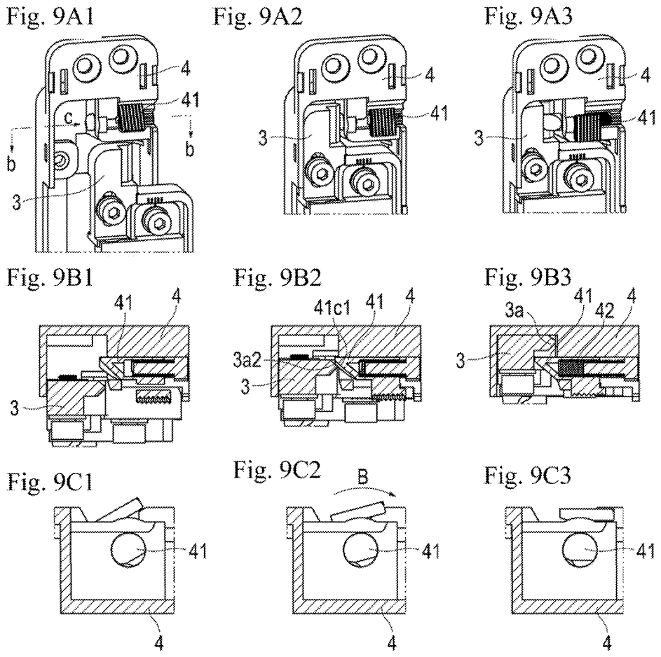

FIG. 9A1-9A3, 9B1-9B3 and 9C1-9C3 show another example of operation diagrams for fitting the hinge body 3 to the base frame 4. In this example, as shown in FIG. 9A1, the operator slides the locking member 41 in the backward direction and then rotates the locking member 41 in the locking direction to hold the position of the locking member 41 at the retracted position (FIG. 9B1). Then, when the hinge body 3 is fitted into the base frame 4, as shown in FIG. 9A2 and 9B2, the second cam surface 3a2 of the cam 3a of the hinge body 3 contacts the first cam surface 41c1 of the cam 41c of the locking member 41, and the locking member 41 slides in the backward direction. At this time, as shown in FIG. 9C2, torque in the unlocking direction B is applied to the locking member 41 by the second cam surface 3a2 of the hinge body 3 and the first cam surface 41c1 of the locking member 41, and the locking member 41 slides while rotating in the unlocking direction B. After that, as shown in FIG. 9A3 and 9B3, when the cam 3a of the hinge body 3 passes over the cam 41c of the locking member 41, the biasing member 42 slides the locking member 41 toward the hinge body 3 to the protruded position. The effects of the hinge according to the present embodiment will be explained below.

According to the hinge 1 of the present embodiment, since the hinge body 3 is temporarily secured to the base frame 4 using the locking member 41 that is slidable relative to the base frame 4, the work of temporarily securing the hinge body 3 to the base frame 4 can be facilitated.

Since the position of the locking member 41 can be held at the protruded position and the retracted position, the hinge body 3 can be easily removed from the base frame 4 or the hinge body 3 can be easily fitted into the base frame 4.

Since the locking member 41 is rotated in the locking direction A and the unlocking direction B to switch the position of the locking member 41 between the retracted position and the protruded position, switching the position of the locking member 41 is easy.

Since the locking member 41 and the biasing member 42 are provided on the base frame 4, the locking member 41 can be arranged on the front side of the hinge body 3 in the temporarily secured state. Thus, it is easy to confirm the temporarily secured state.

### Second Embodiment

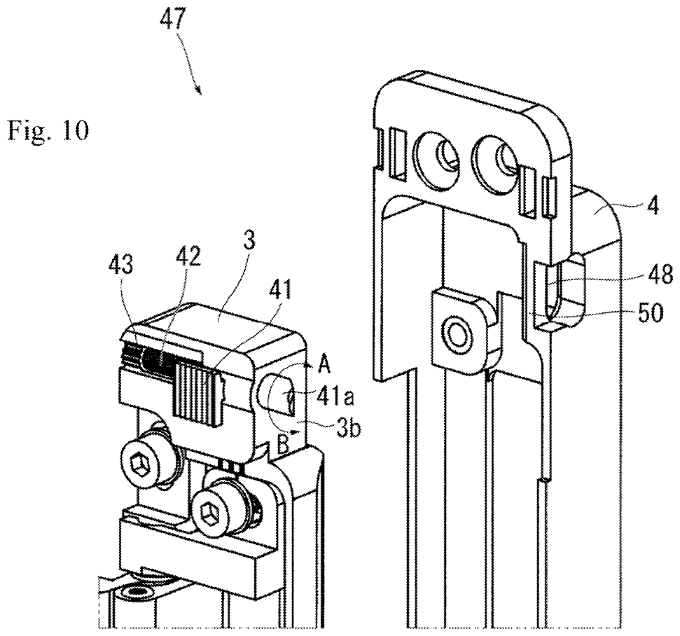

FIG. 10 is a perspective view of a main part of a hinge 47 according to the second embodiment of the present invention. The reference numeral 3 is a hinge body, and the reference numeral 4 is a base frame. In the hinge 47 according to the second embodiment, the locking member 41 and the biasing member 42 are provided on the hinge body 3 side. A hole 48 into which the locking member 41 can be locked is formed in the base frame 4.

The configurations of the hinge body 3 and the base frame 4 are substantially the same as those of the hinge 1 according to the first embodiment except for the above points. Thus, the same reference numerals are assigned and the explanation is omitted. The configurations of the locking member 41, the biasing member 42 and the spring receiver 43 are also substantially the same as those of the hinge 1 according to the first embodiment except for the above points. Thus, the same reference numerals are assigned and the explanation is omitted.

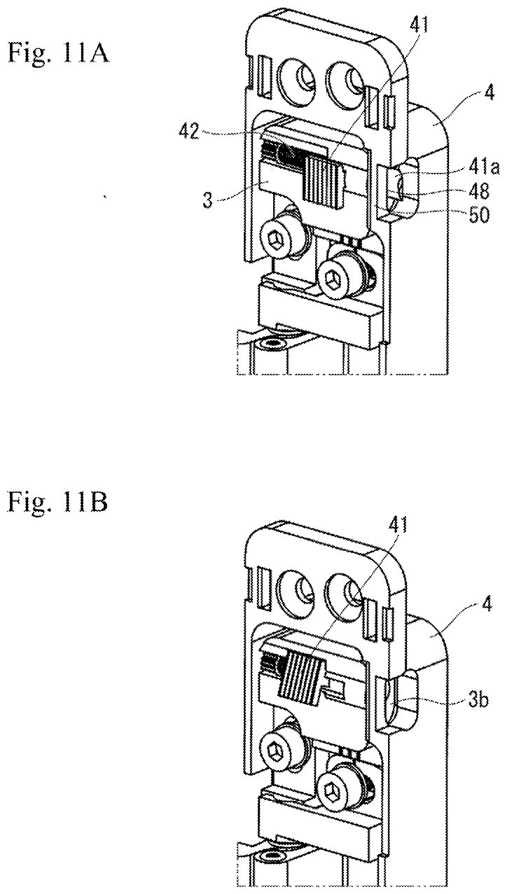

The position of the locking member 41 can be held at the protruded position shown in FIG. 10 and the retracted position shown in FIG. 11B. In the protruded position shown in FIG. 10, the slide shaft 41a of the locking member 41 protrudes from a wall surface 3b of the hinge body 3. In the retracted position shown in FIG. 11B, the slide shaft 41a of the locking member 41 is retracted into the wall surface 3b of the hinge body 3. As shown in FIG. 10, the locking member 41 is rotated in the locking direction A and the unlocking direction B to switch the position of the locking member 41 between the retracted position and the protruded position.

As shown in FIG. 10, when the hinge body 3 is fitted into the base frame 4, the locking member 41 contacts a front wall 50 of the hole 48 of the base frame 4, and the locking member 41 slides in the backward direction. After that, as shown in FIG. 11A, when the locking member 41 passes over the front wall 50 of the base frame 4, the biasing member 42 slides the locking member 41 in the forward direction, and the locking member 41 is locked into the hole 48 of the base frame 4. Therefore, the hinge body 3 can be prevented from coming off from the base frame 4, and the hinge body 3 can be temporarily secured to the base frame 4.

When removing the hinge body 3 from the base frame 4, the operator slides the locking member 41 in the backward direction and then rotates the locking member 41 in the locking direction A to hold the position of the locking member 41 at the retracted position as shown in FIG. 11B. In this state, the hinge body 3 is pulled out from the base frame 4, and the hinge body 3 can be removed from the base frame 4.

According to the hinge 47 of the second embodiment, the following effects are achieved. Since the hinge body 3 is temporarily secured to the base frame 4 using the locking member 41 that is slidable relative to the hinge body 3, the work of temporarily securing the hinge body 3 to the base frame 4 can be facilitated.

Since the position of the locking member 41 can be held at the protruded position and the retracted position, the hinge body 3 can be easily removed from the base frame 4.

Since the locking member 41 is rotated in the locking direction A and the unlocking direction B to switch the position of the locking member 41 between the retracted position and the protruded position, switching the position of the locking member 41 is easy.

The present specification is based on Japanese Patent Application No. 2023-184432 filed on Oct. 27, 2023. The entire contents thereof are incorporated herein.

### DESCRIPTION OF THE REFERENCE NUMERALS

1: hinge
2: hinge body
3: hinge body
4: base frame
41: locking member
42: biasing member
47: hinge
A: locking direction
B: unlocking direction

1. A hinge in which a first hinge body attached to a door and a second hinge body attached to a mounting member of the door are connected so as to be openable and closable,
one of the first hinge body attached to the door or the second hinge body attached to the mounting member of the door is fitted and fixed to a base frame fixed to one of the door or the mounting member of the door,
a locking member is slidably provided on one of the base frame, the first hinge body or the second hinge body,
a biasing member that biases the locking member is provided, and
the first hinge body or the second hinge body is configured to be temporarily secured to the base frame using the locking member.

2. The hinge according to claim 1, wherein
a position of the locking member can be held at a protruded position and a retracted position that is more retracted than the protruded position.

3. The hinge according to claim 2, wherein
the locking member is configured to be rotated in a locking direction and an unlocking direction to switch the position of the locking member between the retracted position and the protruded position.

4. The hinge according to claim 1, wherein
the locking member and the biasing member are provided on the base frame.
